(19) United States
(12) Patent Application Publication
(10) Pub. No.: US 2005/0140813 A1
(43) Pub. Date: Jun. 30, 2005

(54) Camera

(76) Inventor: Yuki Wani, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 10/955,973

(22) Filed: Sep. 30, 2004

(30) Foreign Application Priority Data
Oct. 2, 2003 (JP) 2003-344089
Oct. 2, 2003 (JP) 2003-344090
Oct. 2, 2003 (JP) 2003-344091
Oct. 2, 2003 (JP) 2003-344092

(51) Int. Cl. H04N 5/222

(52) U.S. Cl. 348/333.12

(57) ABSTRACT

A camera includes: a capture unit capturing an image of the subject, and generating image data indicating the image; and a display unit having light permeability from the front to the back of the housing of a camera, generating the image of the subject superposed on the subject seen through from the back, and displaying the image on the back.

### CROSS REFERENCE TO RELATED APPLICATIONS

This application claims benefit of Japanese Applications No. 2003-344089, filed Oct. 2, 2003; No. 2003-344090, filed Oct. 2, 2003; No. 2003-344091, filed Oct. 2, 2003; and No. 2003-344092, filed Oct. 2, 2003, the contents of which are incorporated by this reference.

### BACKGROUND OF THE INVENTION

1. Field of the Invention

The present invention relates to the technology for a camera, and more specifically to the technology for observing, during shooting, the composition of an image to be shot.

2. Description of the Related Art

A camera is provided with a finder to capture a subject with an appropriate composition in a shooting range. Since a small observation hole is made in most finders provided for common cameras, a photographer can lose a good shooting opportunity in a moment when the photographer sets his or her camera and looks into the observation hole.

The view of a finder is the same as or almost as large as a shooting range. Therefore, for example, when a subject moving at a high speed lies off the view of the finder, it is hard to catch the subject in the view of the finder. At this time, it is necessary for the photographer to once take his or her eyes off the view of the finder, and then confirm the position of the subject by the naked eyes.

To solve the above-mentioned problems, a sports finder is well known. A sports finder can catch the shooting range without keeping an eye on the observation hole, and it is not necessary to set a photographer's face close to the camera. Therefore, the photographer can easily observe the outside of the shooting range by the naked eyes, with the posture of observing the view the finder.

The hologram technology has been applied to the above-mentioned sports finder, and has further been improved into what is disclosed by Japanese Patent Laid-open Publication No. Hei 9-65183. The video camera disclosed by the publication is provided with a display device which superposes a subject image on a captured image by the image pickup device by projecting the captured picture on the screen which passes a subject image. The display device provides the function similar to the function of the sports finder, and can observe a captured image.

In addition, the technology of providing the function corresponding to the finder includes an image display device such as an LCD (liquid crystal display), etc. and displays an image captured by an image pickup device as what is called a monitor image on the image display device (for example, refer to Japanese Patent Laid-open Publication No. Hei 11-8786). The photographer can observe the composition of the captured image by checking the displayed image.

Japanese Patent Laid-open Publication No. 2000-261697 discloses a camera capable of shooting while making confirmation on the monitor device when the photographer is also taken as a subject by rotating the monitor device to the subject by connecting the monitor device as rotatable to the body of the camera.

### SUMMARY OF THE INVENTION

A camera which is one of the aspects of the present invention shoots a subject, and includes: a capture unit for capturing an image of the subject, and generating image data indicating the image; and a display unit having light permeability from the front to the back of the housing of a camera, generating the image of the subject superposed on the subject seen through from the back, and displaying the image on the back.

An accessory which is another aspect of the present invention is provided for a camera for shooting a subject, in which the camera includes: a capture unit for capturing an image of the subject and generating image data indicating the image; and a display unit having light permeability from the front to the back of the housing of a camera, generating the image of the subject superposed on the subject seen through from the back, and displaying the image on the back, and the accessory includes an illumination unit for illuminating the display unit.

A camera system according to another aspect of the present invention includes: a camera for shooting a subject and an accessory to the camera, in which the camera includes: a capture unit for capturing an image of the subject and generating image data indicating the image; and a display unit having light permeability from the front to the back of the housing of a camera, generating the image of the subject superposed on the subject seen through from the back, and displaying the image on the back, and the accessory includes an illumination unit for illuminating the display unit.

A camera according to a further aspect of the present invention is a camera for shooting a subject and includes: a capture unit for capturing an image of the subject; a display unit having light permeability from the front to the back of the housing of the camera, displaying an image captured by the capture unit, and also displaying information about the area captured by the capture unit as superposed on the image of the subject seen through from the back; and a shooting area generation unit for generating the information about the area based on the capturing magnification of the image in the capture unit.

A camera which is one of further aspects of the present invention is a camera for shooting a subject and includes: a capture unit for capturing an image of the subject; a display unit having light permeability from the front to the back of the housing of the camera, displaying an image captured by the capture unit, and also displaying information about the area captured by the capture unit as superposed on the image of the subject seen through from the back; and a shootable area generation unit for generating the information about the area based on the shooting conditions in the capturing operation on the image in the capture unit.

A camera which is one of further aspects of the present invention is a camera for shooting a subject and includes: a capture unit for capturing an image of the subject; a display unit having light permeability from the front to the back of the housing of the camera, displaying an image captured by the capture unit, and also displaying at least one of the image of the subject captured by the capture unit and the recorded image captured by the capture unit as superposed on the image of the subject seen through from the back; and a display setting unit for making display setting for an image displayed on the display unit, and the display setting unit makes the display setting based on the shooting condition when the capture unit captures an image.

A camera which is one of further aspects of the present invention is a camera for shooting a subject and includes: a capture unit for capturing an image of the subject; and a display unit having light permeability and displaying on the back of the housing of the camera at least one of the image of the subject captured by the capture unit and the recorded image captured by the capture unit as superposed on the image of the subject seen through from the back of the housing of the camera, and also displaying on the front of the housing of the camera at least one of the image of the subject and the recorded image.

A camera which is one of further aspects of the present invention is a camera for shooting a subject and includes: a capture unit for capturing an image of the subject; a display unit having light permeability and displaying on the back of the housing of the camera at least one of the image of the subject captured by the capture unit and the recorded image captured by the capture unit as superposed on the image of the subject seen through from the back of the housing of the camera; and a lightproof unit for selectively cutting off the light from the back to the front of the housing of the camera.

A camera which is one of further aspects of the present invention is a camera for shooting a subject and includes: a capture unit for capturing an image of the subject; and a display unit, configured using an LCD (liquid crystal display) having light permeability, for displaying on the back of the housing of the camera at least one of the image of the subject captured by the capture unit and the recorded image captured by the capture unit as superposed on the image of the subject seen through from the back of the housing of the camera.

A camera which is one of further aspects of the present invention is a camera for shooting a subject and includes: a capture unit for capturing an image of the subject; and a display unit having light permeability and displaying selectively on one of the front and the back of the housing of the camera at least one of the image of the subject captured by the capture unit and the recorded image captured by the capture unit as superposed on the image of the subject seen through from the back of the housing of the camera.

### BRIEF DESCRIPTION OF THE DRAWINGS

The present invention will be more apparent from the following detailed description when the accompanying drawings are referenced.

FIG. 1A is a front view of the camera embodying the present invention;

FIG. 1B is a right side view of the camera shown in FIG. 1A;

FIG. 1C is a sectional view obtained when the camera is cut along the chain double-dashed line indicated by A-A shown in FIG. 1A;

FIG. 1D is a sectional view obtained when the camera is cut along the chain double-dashed line indicated by B-B shown in FIG. 1A;

FIG. 1E is a sectional view obtained when the camera is cut along the chain double-dashed line indicated by C-C shown in FIG. 1A;

FIG. 1F is a left side view of the camera shown in FIG. 1A;

FIG. 1G is a sectional view obtained when the camera is cut along the chain double-dashed line indicated by D-D shown in FIG. 1A;

FIG. 1H is a top view of the camera shown in FIG. 1A;

FIG. 1I is a back view of the camera shown in FIG. 1A;

FIG. 2 shows the configuration of the camera shown in FIG. 1A;

FIG. 3 shows the first example of the structure of the display unit;

FIG. 4 shows the second example of the structure of the display unit;

FIG. 5A shows the first example of the display screen on the display unit;

FIG. 5B shows the second example of the display screen on the display unit;

FIG. 5C shows the third example of the display screen on the display unit;

FIG. 6A shows the fourth example of the display screen on the display unit;

FIG. 6B shows the fifth example of the display screen on the display unit;

FIG. 7 is an explanatory view showing the relationship between a shooting angle of view and a shooting display frame;

FIG. 8A is a flowchart of the contents of the main flow of the shooting area calculating process;

FIG. 8B is a flowchart of the contents of the width calculating process;

FIG. 9A is an explanatory view (1) of the parallax amendment depending on the distance from a subject;

FIG. 9B is an explanatory view (2) of the parallax amendment depending on the distance from a subject;

FIG. 10A shows the first example of image display during a shooting operation;

FIG. 10B shows the second example of image display during a shooting operation;

FIG. 10C shows the third example of image display during a shooting operation;

FIG. 11A shows the fourth example of image display during a shooting operation;

FIG. 11B shows the fifth example of image display during a shooting operation;

FIG. 11C shows the sixth example of image display during a shooting operation;

FIG. 12 is a flowchart of the contents of the shooting time image displaying process;

FIG. 13A shows the first example of the image display during composite shooting;

FIG. 13B shows the second example of the image display during composite shooting;

FIG. 14 is a flowchart of the contents of the image composite shooting mode process;

FIG. 15A shows the first example of the camera case;

FIG. 15B shows the opened status of the camera case shown in FIG. 15A;

FIG. 16 is an enlarged view of the lens portion of the camera;

FIG. 17 shows the second example of the camera case;

FIG. 18 shows an example of a camera stand; and

FIG. 19 shows the rotation of the holder of the camera stand shown in FIG. 18.

### DESCRIPTION OF THE PREFERRED EMBODIMENTS

An embodiment of the present invention is described below by referring to the attached drawings.

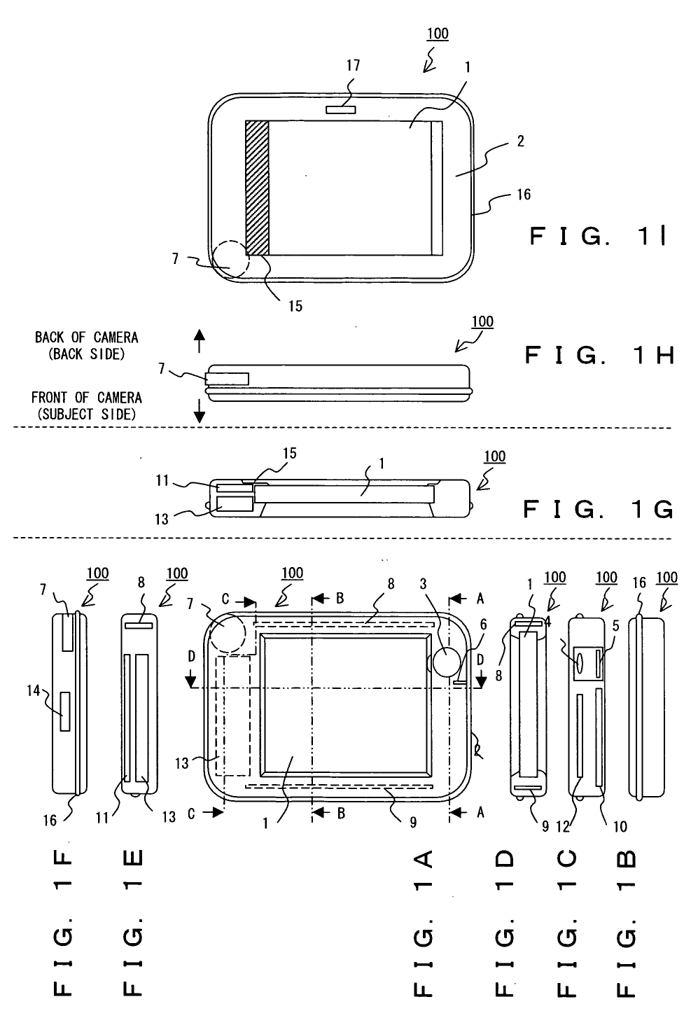

First, FIGS. 1A through 1I are explained below. These figures show the appearance of a camera (digital camera) 100 embodying the present invention and the arrangement of the important portions configuring the camera.

FIGS. 1A through 1F are individually explained as follows. FIG. 1A is a front view of the camera 100, and shows the view of the camera seen from the front. FIG. 1B is a right side view of the camera 100. FIG. 1C is a sectional view obtained when the camera 100 is cut along the chain double-dashed line indicated by A-A shown in FIG. 1A. FIG. 1D is a sectional view obtained when the camera 100 is cut along the chain double-dashed line indicated by B-B shown in FIG. 1A. FIG. 1E is a sectional view obtained when the camera 100 is cut along the chain double-dashed line indicated by C-C shown in FIG. 1A. FIG. 1F is a left side view of the camera 100.

FIGS. 1G through 1I are individually explained below. FIG. 1G is a sectional view obtained when the camera 100 is cut along the chain double-dashed line indicated by D-D shown in FIG. 1A. FIG. 1H is a top view of the camera 100. FIG. 1I is a back view of the camera 100, and the photographer shoots the subject image by observing the subject from the back of the subject positioned in front of the camera 100.

In FIGS. 1A through 1I, the display unit 1 has the light permeability from the front to the back of the thin camera 100, and the photographer can display various images by superposing an image on the subject seen through from the back of the camera 100. The details are explained later, but a display unit 1 includes a transmission display element such as an organic EL (electro luminescence) display element, an ECD (electro chromic display), an LCD, etc. having the above-mentioned light permeability.

The display unit 1 is held by a housing 2. As shown in FIGS. 1A and 1I, the display unit 1 occupies the important area of the front side of the camera 100. The housing 2 functions as the frame indicating the outline of the display unit 1. As shown by FIGS. 1D and 1G, the surface of the display unit 1 is lower than the outline of the housing 2 to protect the display surface of the display unit 1. The opening in the front side of the housing 2 is formed by the inclined surface with the side portions spreading outside. Additionally, the side of the housing 2 is provided with an extended edge 16.

As shown in FIG. 1A, a taking lens hole 3 is provided on the right side (left side viewed from the photographer) of the front of the camera 100. As shown in FIG. 1C, the taking lens hole 3 is loaded with a taking lens 4, and a CCD (charge coupled device) 5 is attached to the image forming position of a subject image formed by the taking lens 4.

As shown in FIG. 1A, an LED (light emitting diode) 6 is arranged below the taking lens hole 3. The LED 6 is used for a notification of release timing to a subject during timer-set shooting.

On the other hand, as shown in FIG. 1A, an operation dial 7 is provided at the upper left end (upper right end of the photographer) of the front of the camera 100, and a part of the circumference of the operation dial 7 is exposed from the housing 2 as an operation unit. The photographer turns or presses the operation dial 7 to issue various instructions to set shooting conditions to the camera 100.

As shown in FIG. 1A, a top substrate 8 is provided at the upper portion inside the housing 2 of the camera 100, and a bottom substrate 9 is provided at the lower portion inside the housing 2 of the camera 100. These substrates are parallel to the bottom of the housing 2. The top substrate 8 and the bottom substrate 9 are printed circuit boards provided with various electronic circuit parts. The top substrate 8 is mainly configured by a circuit for operation control of the camera 100 including a CPU described later. The bottom substrate 9 is mainly configured by a circuit for processing an image such as an image processing unit and a display image generation unit described later.

Additionally, as a similar printed circuit board, as shown in FIGS. 1C, 1E, and 1G, there is a capture substrate 10 at the right inside the front of the housing 2 of the camera 100 on the back perpendicularly to the bottom, and there is a power supply substrate 11 at the left inside the front of the housing 2 of the camera 100 on the front side perpendicularly to the bottom. The capture substrate 10 is configured by the drive circuit of the CCD described later and the control circuit of a built-in memory 12, and the power supply substrate 11 is configured by a circuit of the power supply unit described later.

Furthermore, as shown in FIG. 1C, the built-in memory 12 which is semiconductor memory storing various data such as image data, etc. indicating an image taken by the camera 100 is provided at the right inside the housing 2 of the camera 100. As shown in FIGS. 1A, 1E, and 1G, there is a planar battery 13 which is a power source of the camera 100 at the left inside the front of the housing 2 of the camera 100.

Additionally, a stand contact 14 which is a contact for reception of power supply from a camera stand for setting the camera 100 on when it is not carried by a user is provided on the side of the camera 100 as shown in FIG. 1F.

The main components of the camera 100 according to the present embodiment are arranged as described above. As shown in FIGS. 1G and 1I, to the right of the center of the back of the housing 2 viewed from the photographer, a finger rest 15 is provided as a lowered portion in the back of the housing 2. The camera 100 is based on holding the camera with the right hand of a photographer, and the camera 100 can be easily held by the right portion with the thumb of the right hand of a photographer along the longitudinal direction of the finger rest 15. In the back of the housing 2, there is a window 17 inside of which a light emitting unit 30 for measurement of distance by a photographer and a line sensor 31 described later are mounted.

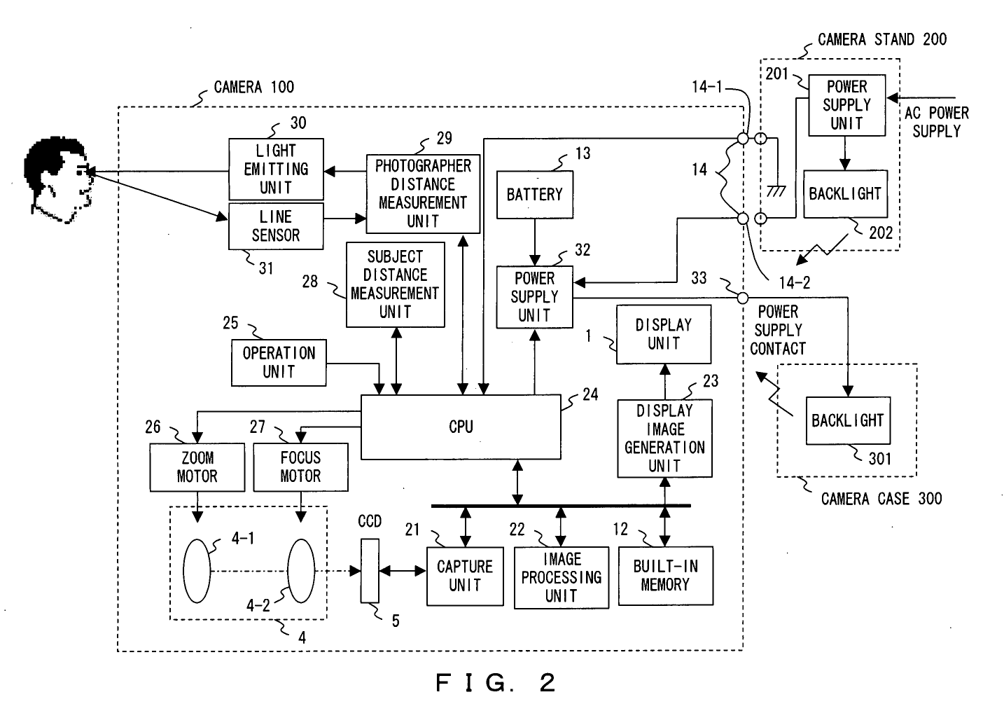

Described below is the configuration shown in FIG. 2. FIG. 2 shows the configuration of the camera 100 shown in FIG. 1. In FIG. 2, the same components as those shown in FIGS. 1A through 1I are assigned the same reference numerals.

The taking lens 4 comprises a zoom lens 4-1 for providing a zoom facility and a focus lens 4-2 for focusing so that a subject image can be formed on the surface of the CCD 5.

The CCD 5 converts the optical image expressing the subject image to an electric signal.

After a capture unit 21 amplifies the electric signal which is an analog signal output from the CCD 5 up to a predetermined level, it converts the amplified signal into a digital signal and outputs image data representing an image of the subject image.

An image processing unit 22 performs image processing such as gamma correction, edge emphasis, white balance correction, etc. of the image represented by the image data on the image data output from the capture unit 21. When the image data is stored in the built-in memory 12, the data compressing process is performed on the image data as necessary.

In response to the instruction from a CPU 24, the built-in memory 12 stores the image data processed by the image processing unit 22, and records the captured image. When an image is regenerated by the camera 100, the image data stored in the built-in memory 12 is read and transferred to a display image generation unit 23.

The display image generation unit 23 generates an image represented by the image data output by the image processing unit 22 when an image is taken, and an image represented by the image data read from the built-in memory 12 when a recorded image is regenerated, and displays the generated image on the display unit 1 in a predetermined position and size. When the image data read from the built-in memory 12 is compressed data, a data decompressing process is performed. Then, a screen for display of the setting status of various information about the operation of the camera 100 transmitted from the CPU 24 such as the diaphragm, the shutter speed, the zoom ratio, etc. is generated and displayed on the display unit 1. Then, a shooting display frame described later is generated at an instruction of the CPU 24, and displayed on the display unit 1.

The CPU (central processing unit) 24 performs the control program prepared in advance to control the operation of the entire camera 100, and performs, for example, the arithmetic process for generating a shooting display frame described later and the process of calculating the brightness of the image captured by the CCD S. The control program can be stored in advance in the CPU 24, or the non-volatile memory (not shown in the attached drawings) such as EEPROM, etc. It also can be stored in advance in semiconductor memory (not shown in the attached drawings) which is readable by the CPU 24, externally attached, and removable.

An operation unit 25 has the operation dial 7, obtains the operation contents of the photographer to the operation dial 7, and notifies the CPU 24 of the operation contents.

A zoom motor 26 and a focus motor 27 respectively move the zoom lens 4-1 and the focus lens 4-2 under the management of the CPU 24.

A subject distance measurement unit 28 measures the distance between the camera 100 and the subject to realize the auto focus (automatic focusing) function. In the present embodiment, to realize the auto focus function in the phase-contrast distance measurement system which is a well-known distance measurement system, an optical/electrical conversion device is provided as the subject distance measurement unit 28, but it is also possible to use a contrast AF for moving the focus lens 4-2 to the position in which the highest contrast of the subject image obtained by the CCD 5 can be adopted by the camera 100. In this case, the subject distance measurement unit 28 is not required as dedicated hardware.

A photographer (user) distance measurement unit 29 measures the distance between the camera 100 and the head (the eye to be more precise) of a photographer (user). According to the present embodiment, the photographer distance measurement unit 29 measures the distance obtained by the well known active system, that is, measures the distance based on the difference (incident angle of infrared) in detection position in which an infrared ray issued by the light emitting unit 30, returned after reflected by the head portion of the photographer, and is detected by a line sensor 31. The details are described later, but the CPU 24 allows the display image generation unit 23 to generate the shooting area frame of a size based on the distance and the zoom ratio by the zoom lens 4-1, and displays it on the display unit 1.

A power supply unit 32 converts the voltage of the battery 13 to a predetermined value and supplies power to each unit of the camera 100. When the attachment to the camera stand 200 having the function as an external power supply is detected by the CPU 24 through the contact 14-1 which is one of the stand contacts 14, the power supply unit 32 which receives the notification from the CPU 24 switches the input such that electric power can be received through the contact 14-2 which is one of the stand contacts 14 from a power supply unit 201 provided for a camera stand 200 instead of the battery 13. When a secondary battery is used as the battery 13, and power is received from the camera stand 200, the battery 13 can be charged.

When the camera 100 is attached to a camera case 300, the power supply unit 32 supplies power to a backlight 301 provided for the camera case 300 through a power supply contact 33. The backlight 301 illuminates the display unit 1 from the front of the camera 100.

When the camera 100 is loaded on the camera stand 200, a backlight 202 provided for the camera stand 200 illuminates the display unit 1 from the front of the camera 100.

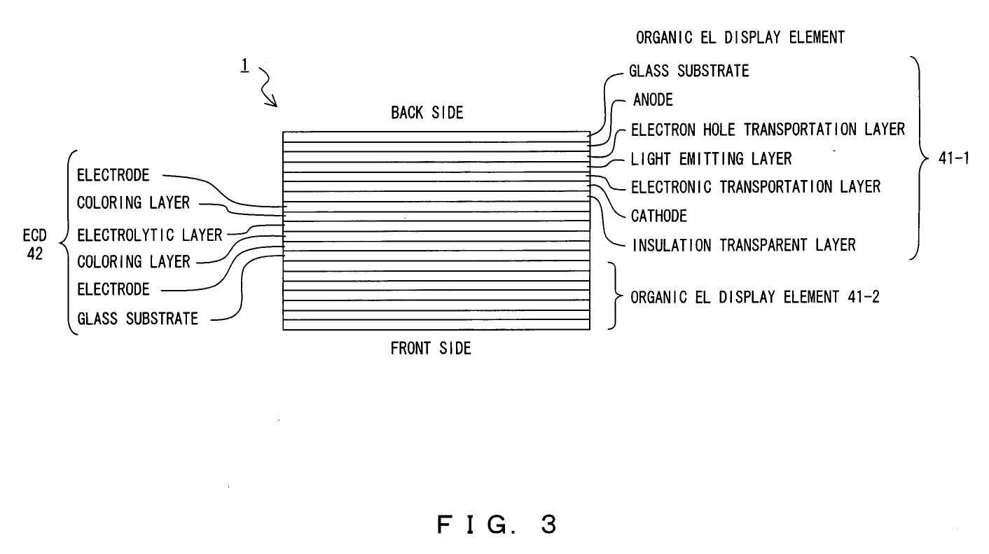

FIG. 3 is explained below. FIG. 3 shows the first example of the display unit 1.

In the first example shown in FIG. 3, a light-transmission organic EL display element 41-1, the ECD 42, and a light-transmission organic EL display element 41-2 are laid in this order, thereby forming the display unit 1.

The organic EL display elements 41-1 and 41-2 are self-light-emitting display elements. The organic EL display element 41-1 displays an image on the back of the camera 100, and the organic EL display element 41-2 displays an image on the front of the camera 100. The internal electrodes of the organic EL display elements 41-1 and 41-2 are formed by a transparent material, and the non-display area in the organic EL display elements 41-1 and 41-2 and the display area in the non-energized status indicate light permeability.

The internal electrode, etc. of an ECD 42 is formed by a transparent material. The ECD 42 cuts off the light transmission when a voltage is applied, and recovers the light permeability when an inverse voltage is applied. Therefore, after setting the ECD 42 in the light transmission status, the current captured image (what is called a monitor image) on the CCD 5 is displayed on the organic EL display element 41-1. Then, the display of the monitor image superposed on the entity of the subject can be presented to the photographer. After setting the ECD 42 in the light transmission status, the image (recorded image) displayed by the data read from the built-in memory 12 is displayed on the organic EL display element 41-1. Then, the display of the recorded image superposed on the entity of the subject can be presented to the photographer.

A monitor image can also be displayed on the organic EL display element 41-2. In this case, for example, when a photographer himself or herself is shot, the photographer's image can be confirmed conveniently on the front side of the camera 100. In this case, the ECD 42 can be set in either the light transmission status or the lightproof status.

It is also possible to simultaneously present the images to a plurality of photographers using the screens on the front (organic EL display element 41-1) and the back (organic EL display element 41-2) of the camera 100.

As described above, when the ECD 42 is operated, the light transmission from the front to the back of the camera 100 can be cut off by applying a predetermined voltage between the electrodes as described later. As a result, a subject cannot be seen through the display unit 1. For example, when an image recorded in the built-in memory 12 is regenerated and displayed on the display unit 1, the light transmission (from the front) is cut off by the ECD 42, thereby improving the visibility of the regenerated image of a current captured image (what is called a monitor image) and captured and recorded image in the CCD 5. On the other hand, as described above, when light is transmitted by the ECD 42, a regenerated image can be observed through the light source and space like a positive slide in a silver salt camera.

The structure of the organic EL display elements 41-1 and 41-2 shown in FIG. 3, that is, the structure obtained by laying a glass substrate, an anode, a electron hole transportation layer, a light emitting layer, an electronic transportation layer, a cathode, and an insulation transparent layer in this order is well known, and the structure of the ECD 42 shown in FIG. 3, that is, the structure obtained by laying a glass substrate, an electrode, a coloring layer, a electrolytic layer, a coloring layer, and an electrode in this order is also well known.

The structure of the ECD 42 shown in FIG. 3 is laid such that the light transmission from the front to the back of the camera 100 can be cut off, but it can be laid such that the light transmission from the back to the front of the camera 100 can be cut off. Thus, the visibility of the regenerated image of a current captured image (what is called a monitor image) and captured and recorded image in the CCD 5 displayed on the organic EL display element 41-2 on the front side of the camera 100 can be improved.

In the example shown in FIG. 3, the display unit 1 is configured by laying the organic EL display element 41-1, the ECD 42, and the organic EL display element 41-2 in this order from the back to the front, but the display unit 1 can be configured by laying the organic EL display element 41-1, the organic EL display element 41-2, and the ECD 42 in this order from the back to the front of the camera 100, or can be configured by laying the ECD 42, the organic EL display element 41-1, and the organic EL display element 41-2 in-this order from the back to the front of the camera 100.

In FIG. 3, the ECD 42 is used to cut off the light transmission from the front to the back of the camera 100 and from the back to the front of the camera 100, but a similar cutoff effect can be obtained using the LCD instead of the ECD 42.

The above-mentioned display unit 1 is configured by two organic EL display elements and the ECD or LCD for cutting light off, but it also can be configured by one organic EL display element and the ECD or LCD for cutting light off.

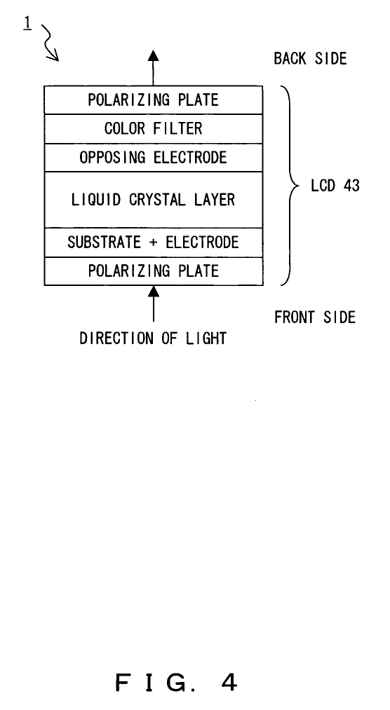

On the other hand, the second example shown in FIG. 4 is the display unit 1 formed by a light transmission LCD 43 in which a photographer can visually recognize by superposing the display on the subject image from the back of the camera 100 by operating the LCD 43 with the light received from the front of the camera 100.

The structure of the light transmission LCD 43 shown in FIG. 4, that is, the structure obtained by laying a polarizing plate, a substrate and an electrode, a liquid crystal layer, an opposing electrode, a color filter, and a polarizing plate in this order is also well known.

Then, an example of a display screen of the display unit 1 of the camera 100 and the process performed by the CPU 24 for display of the screen on the display unit 1 are explained below.

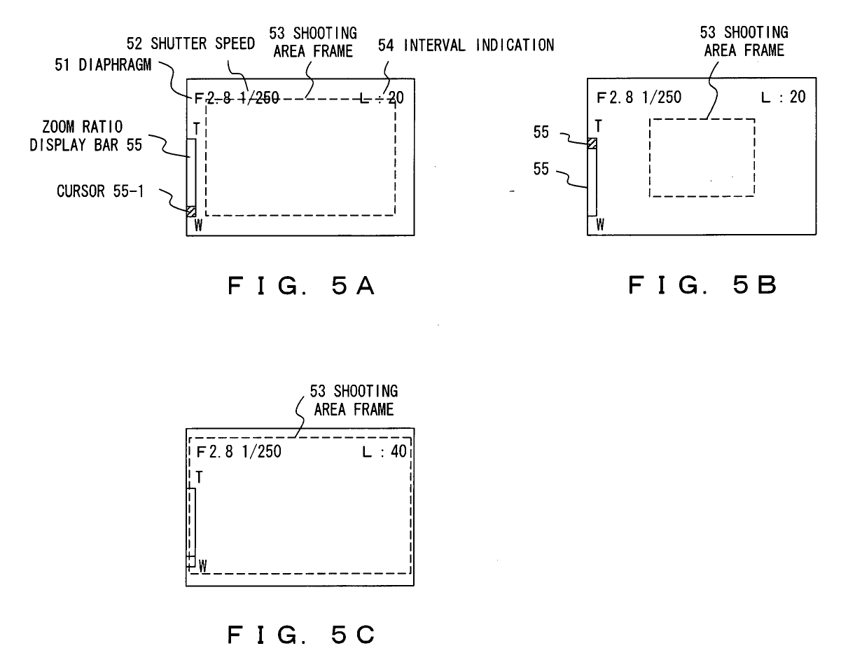

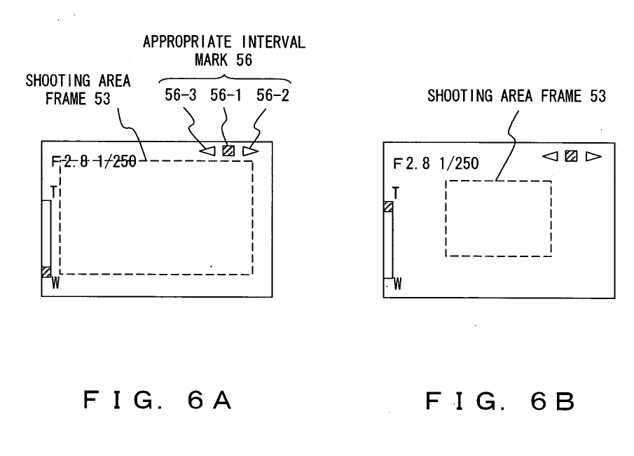

First, examples of display screens shown in FIGS. 5A, 5B, 6A, and 6B are explained below. These figures are the examples of the display screens of the display unit 1. These figures show the screens for display of various information relating to the shooting by the camera 100 which are displayed on the display unit 1 when the camera 100 according to the present embodiment is in the operation mode (hereinafter referred to as a “shooting mode”) for a shooting operation.

First, the components of the display screens are explained by referring to FIG. 5A.

In FIG. 5A, a reference numeral 51 designates a current set value of the diaphragm of the taking lens 4, and a reference numeral 52 designates a current set value of the shutter speed.

A shooting area frame 53 indicates a range to be recorded as a captured image in the landscape including the subject seen through the display unit 1 by a photographer. The subject seen through by the display unit 1 is regardless of the set position of the zoom lens 4-1, that is, the zoom ratio. Therefore, it is necessary to set the shooting area frame 53 corresponding to a change of the shooting area due to a change of a zoom ratio. Unlike the conventional look-in finder, the display unit 1 permits the selection of the interval between the display unit and the eye of a photographer, and the subject size seen through by the interval depends on the interval. Therefore, it is necessary to set a shooting area frame with the above-mentioned condition taken into account.

An interval indication 54 refers to a value indicating the interval between the camera 100 and the head portion of a photographer, and is a measurement result.

A reference numeral 55 designates a zoom ratio display bar. A cursor 55-1 displays the current zoom position. Depending on the display position in the zoom ratio display bar 55 of the cursor 55-1, the current setting of the zoom lens 4-1 is indicated. The practical explanation of the display of the zoom ratio display bar 55 is given below. That is, the display shown in FIG. 5A shows that the zoom lens 4-1 is set at the wide (wide-angle)-end, and the display shown in FIG. 5B shows that the zoom lens 4-1 is set at the telephoto-end.

When FIG. 5A is compared with FIG. 5B, they are different in display of the zoom ratio display bar 55, and different in size of the shooting area frame 53. This indicates that, in FIG. 5B, the zoom lens 4-1 has a smaller recordable range as a captured image in the landscape containing a subject seen through the display unit 1 by the photographer as a result of setting the zoom lens 4-1 at the telephoto-end than that shown in FIG. 5A.

As shown by the interval indication 54 between the camera 100 and the head portion of the photographer, FIG. 5C shows the status in which the head portion of the photographer becomes farther from the camera 100 than that shown in FIG. 5A (the interval is extended from 20 cm to 40 cm). In the display shown in FIG. 5C, the shooting area frame 53 is extended farther than in FIG. 5A by the above-mentioned extended amount, thereby appropriately enclosing the range recorded as a captured image in the landscape containing the subject seen through the display unit 1 by a photographer.

FIGS. 6A and 6B are explained below. FIG. 6A shows the screen display when the zoom lens 4-1 is set at the wide-end. FIG. 6B shows the screen display when the zoom lens 4-1 is set at the telephoto-end.

The display screens shown in FIGS. 6A and 6B are different from those shown in FIGS. 5A and 5Ba in that an appropriate interval mark 56 is displayed instead of the interval indication 54 between the camera 100 and the head portion of the photographer so that an appropriate shooting area can be visually recognized. The appropriate interval mark 56 is the display indicating whether or not the interval measured by the photographer distance measurement unit 29 between the camera 100 and the head portion of the photographer is appropriate for the value set in the camera 100 in advance, for example, the visible distance (the distance at which a person having a normal sight can easily and correctly see an object) of 25 cm˜30 cm. If the distance is appropriate (within the range of an appropriate value), mark 56-1 is displayed brightly. If it is short, mark 56-2 is displayed brightly. If it is long, mark 56-3 is displayed brightly. The appropriate interval mark 56 is an announcement device for announcement as to whether or not the distance is within a predetermined range. The announcement can be made by sound.

The relationship of the sizes of the shooting area frame 53 between FIGS. 6A and 6B is the same as that between FIG. 5A and 5B.

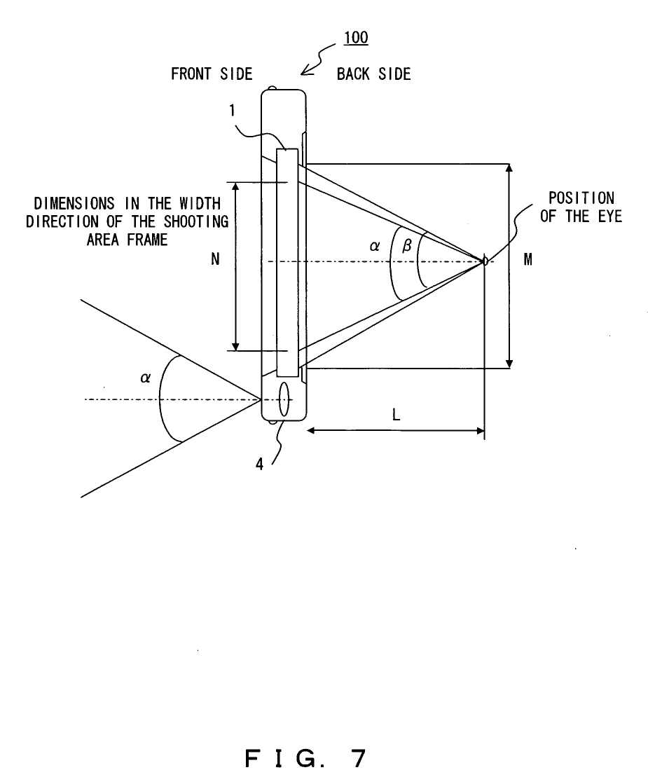

The relationship between the shooting angle of view of the camera 100 and the shooting area frame 53 is explained by referring to FIG. 7.

FIG. 7 is a top view of the camera 100. The left to the camera 100 is the front side of the camera 100, and the right is the back side of it. In FIG. 7, it is assumed that the eye of a photographer is positioned on the straight line perpendicular to the display plane of the rectangular display unit 1 and passing the center of the plane.

A variable shown in FIG. 7 is explained below.

L indicates the interval between the camera 100 and the eye of a photographer, and the distance between the camera 100 measured by the photographer distance measurement unit 29 and the head portion of the photographer is used.

α indicates a shooting angle of view, and depends on the taking lens 4. The value changes depending on the setting of the zoom ratio.

At this time, the width N of the shooting area frame 53 is to be set such that the visual angle at which the eyes of the photographer see the vertical line on both sides of the 53 can be α. That is, the following equation holds.
N=2×L tan (α/2) (1)

However, assuming that the width of the display unit 1 is M, the visual angle β when the eyes of a photographer see both ends of the display unit 1 is calculated by the following equation.
β=2×tan⁻¹ (M/2/L) (2)

Therefore, the shooting area frame 53 is displayed on the display unit 1 only when β≧α.

The above-mentioned explanation is given only for the width of the shooting area frame 53, but the length and the width of the shooting area frame 53 can be similarly explained.

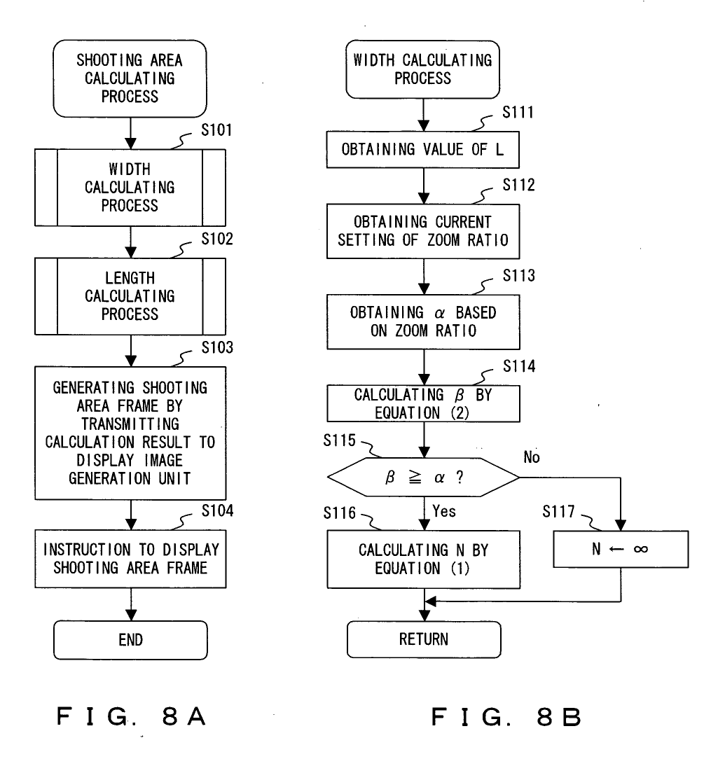

Described below is the shooting area calculating process shown in the flowchart in FIGS. 8A and 8B. The process is to generate and display the shooting area frame 53 indicated in the display screen examples shown in FIGS. 5A, 5B, and 5C. This process is performed by the CPU 24 executing the above-mentioned control program, calculates the dimensions of the shooting area frame 53 based on the above-mentioned explanation, allows the display image generation unit 23 to generate the shooting area frame 53 of the dimensions, and displays the result on the display unit 1.

The process is started at predetermined intervals when the camera 100 is set in the shooting mode.

First, the main flow of the shooting area calculating process shown in FIG. 8A is explained.

In S101, the process of calculating the width of the shooting area frame 53 is performed. In S102, the process of calculating the length of the shooting area frame 53 is performed.

In S103, the valued of the width and the length of the shooting area frame 53 calculated in the processes in S101 and S102 are transmitted to the display image generation unit 23, and the shooting area frame 53 is generated.

In S104, an instruction to display the generated shooting area frame 53 in the center of the display unit 1 is issued to the display image generation unit 23. Afterwards, the shooting area calculating process terminates, and the CPU 24 performs another process.

Next, the width calculating process shown in FIG. 8B is explained below. This process is performed in S101 shown in FIG. 8A.

First, in S111, the value of the interval L between the camera 100 and the eye of a photographer is obtained from the measurement result by the photographer distance measurement unit 29.

In S112, the current setting of the zoom ratio obtain by the current position of the zoom lens 4-1 controlled by the CPU 24 is obtained. In S113, the shooting angle of view α at the zoom ratio is obtained by referring to the table prepared in advance.

In S114, the predetermined value of the width M of the display unit 1 and the value of L obtained in the process in S111 is assigned to the equation (2), and the visual angle β when the eyes of a photographer see both ends of the display unit 1 is calculated.

In S115, the value of α obtained in the process in S113 is compared with the value of β calculated in the process in S114. If β≧α (YES as a result of the determination result in S115), control is passed to step S 116. If β<α (NO as a result of the determination result in S115), control is passed to step S 117.

In S116, the value of L obtained in the process in Sill and the value of α obtained in the process in S113 are assigned to the equation (1) above, the width N of the shooting area frame 53 is calculated, and then the width calculating process is terminated, thereby returning control to the original process.

In S117, the calculation result of the value of the width N of the shooting area frame 53 is defined as ∞ (infinity), and then the width calculating process is terminated, thereby returning control to the original process.

The processes described above are the width calculating process. When ∞ is transmitted from the CPU 24 as a value of the width N, the display image generation unit 23 prevents the vertical pole on both sides configuring the shooting area frame 53 from being displayed on the display unit 1.

The contents of the length calculating process in S102 shown in FIG. 8A are similar to those of the width calculating process shown in FIG. 8B. Therefore, the explanation is omitted here.

By the CPU 24 performing the above-mentioned processes, the shooting area frame 53 is displayed on the display unit 1.

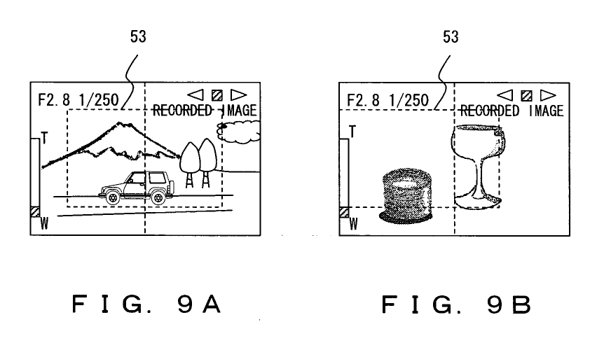

In the above-mentioned shooting area calculating process, the shooting area frame 53 generated by the display image generation unit 23 is displayed in the center of the display unit 1. However, the influence of what is called parallax caused by the difference in position between the taking lens 4 and the eye of a photographer becomes outstanding by the macro shooting which is performed near a subject. Therefore, the influence of the parallax can be broken up by changing the display position of the shooting area frame 53 in the display unit 1 based on the distance between the camera 100 and the subject. The parallax amendment depending on the distance from a subject is explained by referring to FIGS. 9A and 9B.

FIG. 9A shows a display screen of the display unit 1 in the operation of shooting a distance as a subject. In this case, no parallax amendment is required. Therefore, the shooting area frame 53 is displayed in the center of the display surface of the display unit 1. On the other hand, FIG. 9B indicates the display screen of the display unit 1 during the operation of shooting a near distance. In this case, to make a parallax amendment, the shooting area frame 53 is displayed at the upper left end of the display surface of the display unit 1. That is, the shooting area frame 53 shown in FIG. 9B displays the shooting area frame 53 at a position closer to the position of the taking lens 4 of the camera 100, and the range of an image shot by the taking lens 4 is more appropriately reflected.

To display the shooting area frame 53 depending on the distance from a subject, for example, in the step of the shooting area calculating process in S104 shown in FIG. 8A, the CPU 24 is allowed to perform the processes of: obtaining the distance between the camera 100 and a subject measured by the subject distance measurement unit 28; obtaining the display position in the display unit 1 of the shooting area frame 53 in this distance by referring to a predetermined table; and issuing an instruction to display the shooting area frame 53 in this position to the display image generation unit 23.

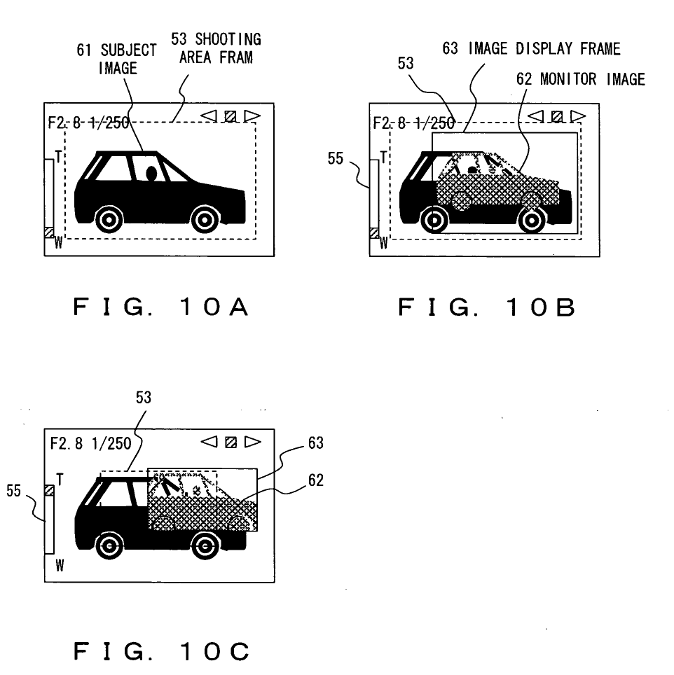

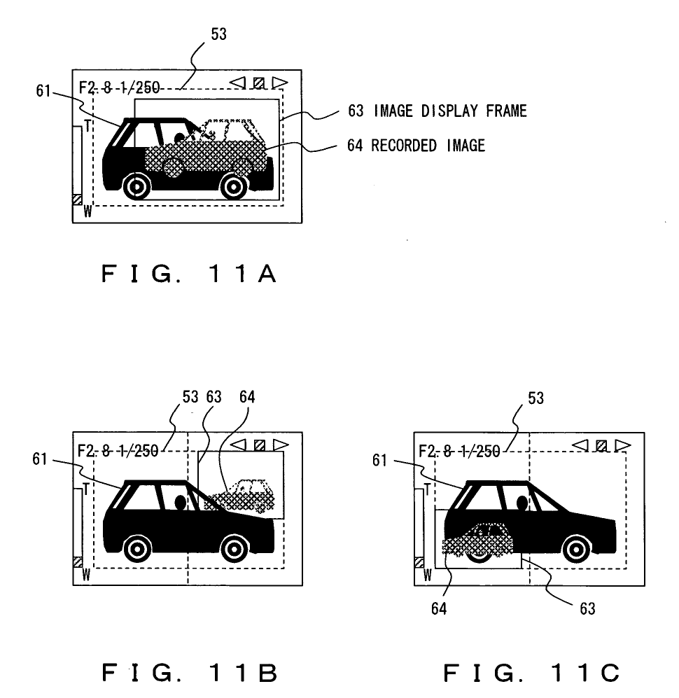

Next, the image display on the display unit 1 when the camera 100 is operating in the shooting mode is explained by referring to FIGS. 10A, 10B, and 10C, and 11A, 11B, and 11C.

In the camera 100, in the shooting mode, the monitor images continuously captured by the CCD 5 and the recorded image stored in the built-in memory 12 can be displayed on the display unit 1 for seeing through a subject for confirmation of the subject.

In the display example shown in FIG. 10A, the display unit 1 sees through a subject image 61 about a subject (in FIG. 10A, a car). At this time, as shown in FIG. 10B, when a photographer operates the operation dial 5 and issues a predetermined instruction to the camera 100, a monitor image 62 of a subject shot by the CCD 5 at that time is displayed in an image display frame 63 of the display unit 1, and the photographer can see laid images of the subject image 61 and the monitor image 62.

As clearly shown in the zoom ratio display bar 55, the zoom lens 4-1 is set at wide-end as shown in FIG. 10B. When the photographer operates the operation dial 5 and issues an instruction to move the zoom lens 4-1 to a telephoto-end, the shooting area frame 53 is reduced in size and the monitor image 62 displayed in the image display frame 63 is enlarged. The display of the display unit 1 when the zoom lens 4-1 is moved to the telephoto-end from the status shown in FIG. 10B is an example of image display shown in FIG. 10C.

FIGS. 11A, 11B, and 11C show examples of display when the image displayed on the display unit 1 is replaced with the monitor image 62 which is used as a recorded image in the built-in memory 12.

In FIG. 11A, when the display unit 1 makes the subject image 61 of a subject be seen through, the photographer operates the operation dial 7 and issues a predetermined instruction to the camera 100, and thus the recorded image (recorded image 64) relating to the instruction indicates the status of the display in the image display frame 63 of the display unit 1. Therefore, the photographer sees a laid image of the subject image 61 and the recorded image 64.

The photographer issues a predetermined instruction to the camera 100 by operating the operation dial 7 in the display status shown in FIG. 11A, thereby changing the size and the display position of the recorded image 64 displayed on the display unit 1 as shown in FIGS. 11B and 11C.

Depending on the change of shooting conditions when the photographer changes the zoom ratio or the distance from the subject image 61, or when the brightness changes by the change of weather or a shooting place, etc., as shown in FIGS. 11B and 11C, the photographer can easily and appropriately recognize the subject image 61 and the image display frame 63. Also when a monitor image is displayed on the display unit 1 shown in FIGS. 10A, 10B, and 10C, similar process can be realized.

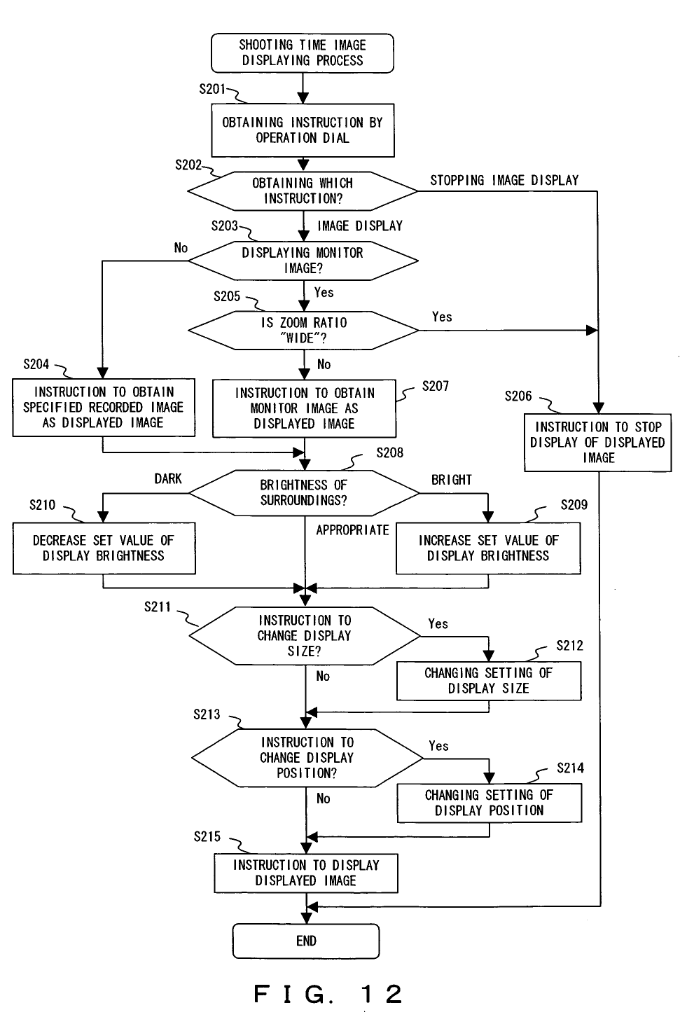

Described below is the shooting time image displaying process which is the process performed by the CPU 24 to allow the display unit 1 display the screen as shown in FIGS. 10A, 10B, and 10C, and FIGS. 11A, 11B, and 11C when the camera 100 is operating in the shooting mode. FIG. 12 shows a flowchart showing the contents of the process.

This process is also performed by the CPU 24 executing the control program as in the shooting area calculating process shown in FIGS. 8A and 8B, and when the camera 100 is set in the shooting mode, the operation is started at predetermined intervals.

First, in S201, the process of obtaining the contents of the instruction corresponding to the operation performed on the operation dial 7 is performed.

In S202, it is determined whether the contents of the instruction relates to the display of an image, or relates to the stop of the display of an image. If the instruction relates to the display of an image, control is passed to S203. If the instruction relates to the stop of the display of an image, control is passed to S206.

In S203, it is determined whether or not the contents of the instruction indicate a display request. If the determination result is YES, control is passed to S205. If the determination result is NO in S203, then it is assumed that a display request for the recorded image 64 is made, an instruction is issued to the display image generation unit 23 in S204, the image data relating to an instruction to the operation dial 7 is read from the built-in memory 12, and an image decompressing process is performed and a process of obtaining a displayed image is performed, thereby passing control to S208. The display image generation unit 23 performs a process according to an instruction from the CPU 24.

In S205, the setting of the current zoom ratio in the zoom by the zoom lens 4-1 is obtained, and it is determined whether or not the zoom ratio indicates the “wide” status, that is, the zoom lens 4-1 is positioned at the wide-end. If the determination result in S205 is YES, then an instruction is issued to the display image generation unit 23 in S206, and the display of a displayed image performed in the display unit 1 is performed, and the display image generation unit 23 performs a process at an instruction of the CPU 24. When the process in S206 is terminated, the shooting time image displaying process terminates, and the CPU 24 performs another process.

On the other hand, if the determination result in S205 is NO, then control is passed to S207, an instruction is issued to the display image generation unit 23, and the CCD 5 performs a process of obtaining image data (monitor image) indicating the shot image as displayed image from the capture unit 21.

When the zoom ratio of the camera 100 is in the “wide” status, the determining process in S205 is performed so that power consumption can be reduced by suppressing the display of the monitor image 62 although a photographer issues a display request for the monitor image 62. Although the zoom ratio of the camera 100 is in the “wide” status as in the display example shown in FIG. 10B, the monitor image 62 can be displayed by deleting the process in S205 from the flowchart shown in FIG. 12. If the determination result is YES in S203, control is passed to S207.

In S208, the image data representing the image captured by the CCD 5 is obtained from the capture unit 21, and the brightness of the entire image, that is, the brightness of the surrounding portion of the camera 100 is calculated, and it is determined whether or not the calculation result is in a range of an appropriate value. If the brightness is in the range of the appropriate value, then control is passed to S211. If the brightness is higher than the appropriate value, the setting of the brightness when the displayed image is displayed on the display unit 1 in S209 is enhanced, and then control is passed to S211. If the brightness is lower than the appropriate value, then the brightness at which a displayed image is displayed on the display unit 1 is set lower in S210. Afterwards, control is passed to S211. In the processes in S208 through S211, when the organic EL display element which is a self-emitting display element is used as the display unit 1, the display brightness is changed depending on the brightness of the surroundings of the camera 100, thereby improving the visibility of the displayed image.

In S211, it is determined whether or not an instruction to change the display size of a displayed image has been issued by the operation of the operation dial 7. Only when the determination result is YES, the change of the setting of the display size of a displayed image is indicated to the display image generation unit 23 in S212.

In S213, it is determined whether or not an instruction to change the display position of a displayed image has been issued by the operation of the operation dial 7. Only when the determination result is YES, the change of the setting of the display position of a displayed image is indicated to the display image generation unit 23 in S214.

For example, as shown in FIG. 11A, if there is a large area in which the display of the subject image 61 is superposed on the display of the recorded image 64, when a photographer operates the operation dial 7 and issues an-instruction, the processes in S212 and S214 are performed by the CPU 24, and as shown in FIGS. 11B and 11C, the size of the recorded image 64 is reduced, and the subject image 61 is moved to a position in which it can be visually recognized. As a result, it is possible to easily and appropriately recognize a subject and a captured image or a recorded image visually. Furthermore, the relationship between the subject and the captured image can be appropriately recognized visually.

In S215, the display instruction of a displayed image to the display unit 1 is transmitted. Upon receipt of the instruction, the display image generation unit 23 displays the displayed image of a predetermined size together with the image display frame 63 in a predetermined position in the display unit 1.

After performing the process in S215, the shooting time image displaying process terminates, and the CPU 24 performs other processes.

The process in S212 is performed when an instruction to change the display size of a displayed image is issued by the operation of the operation dial 7. However, the setting information of the current zoom ratio in the zoom by the zoom lens 4-1, and the distance information between the camera 100 and the subject obtained by the subject distance measurement unit 28 is read by CPU 24, and by referring to the setting information prepared in advance and the table of a display size depending on the distance information, a display size of a displayed image is determined so that a process of indicating to the display image generation unit 23 can be performed.

Similarly, the process in S213 is performed when an instruction to change the display position of a displayed image is issued in the operation of the operation dial 7, but it is also possible to perform the process of indicating to the display image generation unit 23 by the CPU 24 reading the setting information about the current zoom ratio and the distance information between the camera 100 and the subject, and determining the display position by referring to the table of a display position.

The above-mentioned processes are the shooting time image displaying process, and the CPU 24 performs the processes, thereby performing display setting based on the indication from the operation dial 7 and shooting condition during a shooting operation. The images shown in FIGS. 10A, 10B, 10C, 11A, 11B, and 11C are displayed on the display unit 1.

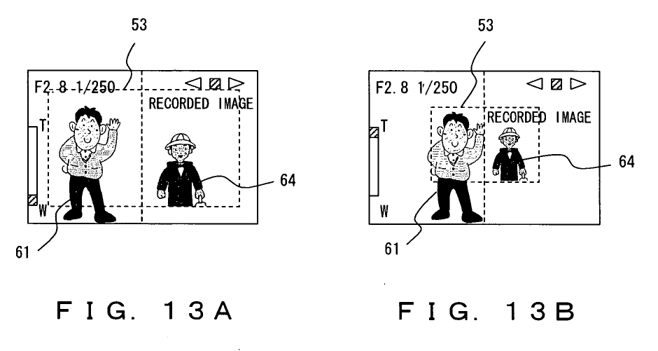

Then, the image composite shooting which is one of the application shooting operation which can be performed using the camera 100 is described below by referring to an example of image display shown in FIGS. 13A and 13B.

FIGS. 13A and 13B show examples of image display during composite shooting. FIG. 13A shows the case in which the zoom ratio of the camera 100 is in the “wide” status, and FIG. 13B shows the case in which the zoom ratio of the camera 100 is in the “telephoto” status.

In the examples of display screen shown in FIGS. 13A and 13B, the display unit 1 displays the shooting area frame 53, and, on the left in the shooting area frame 53, the subject image 61 of the subject (a person in FIGS. 13A and 13B) is seen through. On the other hand, on the right in the shooting area frame 53, the recorded image 64 relating to an instruction from a photographer is displayed. The display size of the recorded image 64 changes depending on the size of the shooting area frame 53, that is, the zoom ratio of the camera 100.

When the photographer operates the operation dial 7 with the screen displayed on the display unit 1 and issues a release instruction, a subject is taken, and a composite image of the subject image 61 and the recorded image 64 arranged side by side is generated and stored in the built-in memory 12 as the screen display in the shooting area frame 53. This is the image composite shooting by the camera 100.

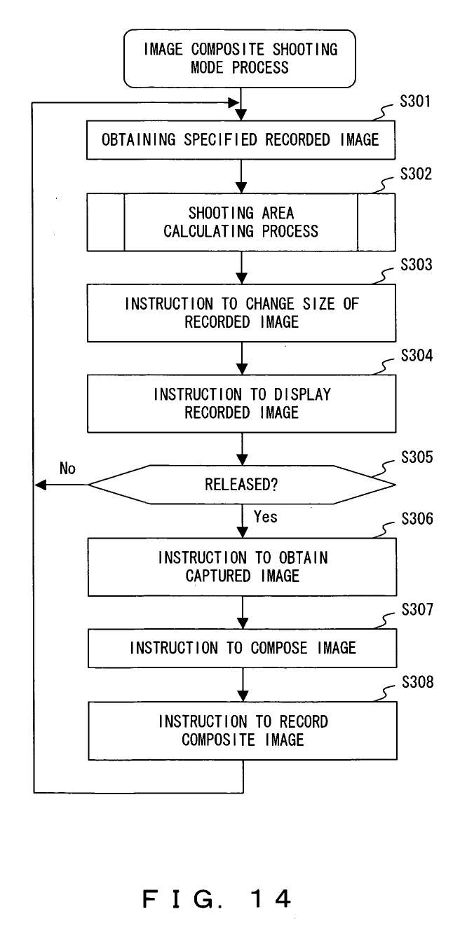

The image composite shooting mode process performed by the CPU 24 when a mode change instruction is issued to the image composite shooting mode which is an operation mode for performing image composite shooting in the camera 100 by the photographer operating the operation dial 7 is explained below. FIG. 14 is a flowchart of the contents of the process.

The process is performed by the CPU 24 executing the above-mentioned control program as in the shooting area calculating process shown in FIGS. 8A and 8B.

First, in S301, an instruction is given to the display image generation unit 23, and the image data of the recorded image relating to the instruction from the photographer is read from the built-in memory 12, and data is decompressed.

In S302, the shooting area calculating process is performed, and the shooting area frame 53 is displayed on the display unit 1.

In S303, an instruction is issued to the display image generation unit 23 to change the size of a recorded image as the size of the right half of the shooting area frame 53.

In S304, an instruction is given to the display image generation unit 23, and the recorded image whose size has been changed in the process in the step is displayed in the right half of the area in the shooting area frame 53 of the display unit 1.

In S305, it is determined whether or not the operation to the operation dial 7 by a photographer has performed release (shoot instruction). If the release is confirmed (YES in determination result), control is passed to S 306. On the other hand, if the released is not confirmed (NO in determination result), control is returned to S301, and the above-mentioned processes are repeated.

In S306, an instruction is issued to the image processing unit 22, the CCD 5 obtains the image data of the captured image of the subject image 61 taken at this time according to the predetermined shooting conditions.

In S307, an instruction is issued to the image processing unit 22, the left half of the captured image as display of the subject image 61 and the recorded image 64 which is the right half size of the shooting area frame 53 are arranged side by side to generate a composite image.

In S308, an instruction is issued to the image processing unit 22, the image data representing the composite image generated in the previous step is data-compressed, and the compressed composite image data is stored in the built-in memory 12. Afterwards, control is returned to S301, and the above-mentioned processes are repeated.

The above-mentioned processes are the image composite shooting mode process, and by performing the process by the CPU 24, a person who is a subject and a person who is a captured image can be taken as a composite image.

In the above-mentioned image composite shooting mode process, a person who is a subject is positioned on the left and a person who has been a captured image is positioned on the right when a composite image is generated. However, the arrangement can be easily changed. It is also possible to generate a composite image by displaying a captured image in any position in the shooting area frame 53 by specifying the size and display position of the recorded image 64 using the operation dial 7.

Since the camera 100 is configured as shown above, it is small, thin, and capable of confirming a captured image using a transparent optical finder as if a user were operating a slide. Furthermore, a photographer using the camera 100 can easily and correctly recognize the relationship between the entire image of a subject and a captured image visually. Furthermore, although a photographer the photographer is a subject, the photographer can easily confirm and take the image of the photographer. It is also possible to confirm an image of a subject and a recorded image using one camera 100.

One of the accessories to the camera 100 is a camera case 300 whose shape is described above.

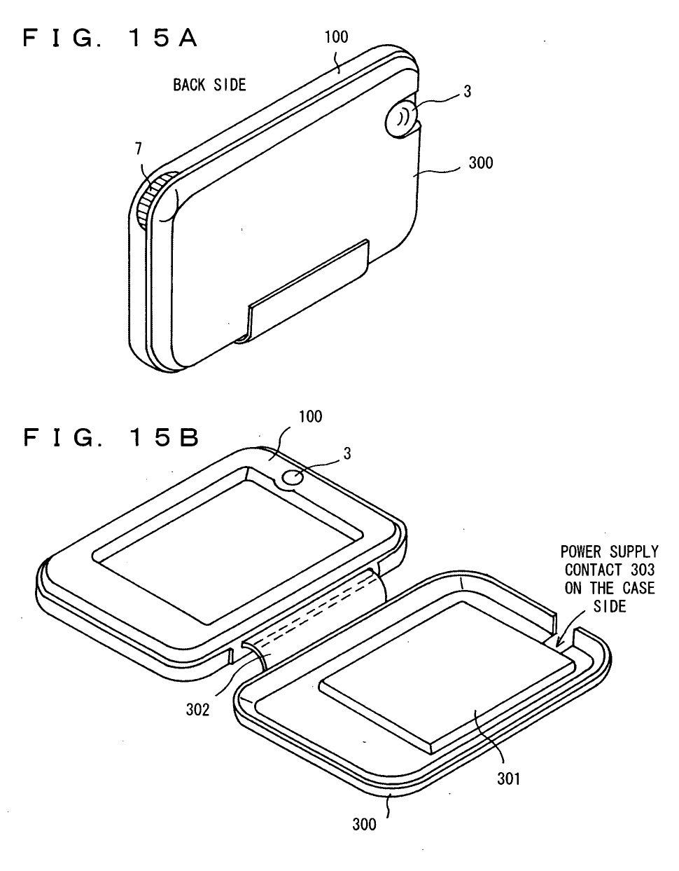

FIGS. 15A and 15B show the first example of the camera case 300. By covering the front of the camera 100 with the camera case 300, the front side of the camera 100 can be covered with the camera case 300. FIG. 15A shows the use of the camera case 300. FIG. 15B shows the open status of the camera case 300. The camera case 300 is made of a thin material such as leather, plastic, or a metal plate with deep drawing, etc.

FIG. 15A shows an opening on the camera case 300 for the disclosure of the taking lens hole 3 of the camera 100 with the camera case 300 covering the camera 100. Therefore, the camera 100 can take a picture even using the camera case 300.

As shown in FIG. 15B, the camera case 300 can be combined with the camera 100 with the flexible hinge 302 applied to the bottom of the housing 2 of the camera 100 engaged with the opening of the long slot. Furthermore, when the display object to be used in the display unit 1, for example, an LCD which is a non-self-emitting is used, the inside of the camera case 300 is configured to include the backlight 301 illuminating the display unit 1 from the front side of the camera 100. The size of the backlight 301 is appropriate to be incorporated into the concave portion of the front side.

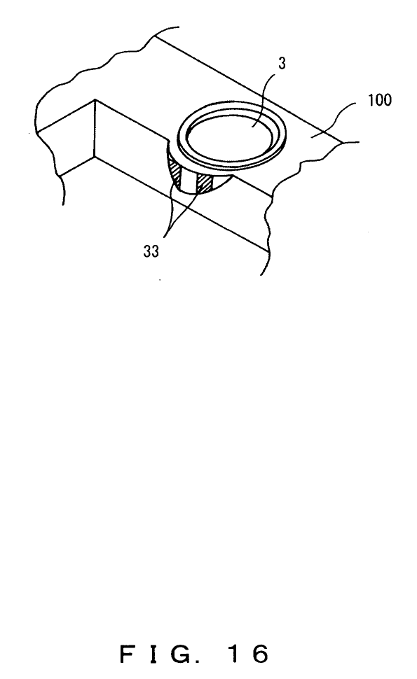

The power to turn on the backlight 301 is supplied by the camera 100. FIG. 16 shows the enlarged portion of the lens 3 of the camera 100. As shown in FIG. 16, the portion of the lens 3 is provided with the power supply contact 33 for output of power to the backlight 301. On the other hand, as shown in FIG. 15B, in the position contacting the power supply contact 33 of the camera 100 when the camera 100 is covered with the camera case 300, a power supply contact 303 on the case side is provided. Therefore, when the camera 100 is covered with the camera case 300, power is supplied from the camera 100 to the backlight 301, and the backlight 301 is turned on, thereby illuminating the display unit 1 and the displayed image can be recognized visually.

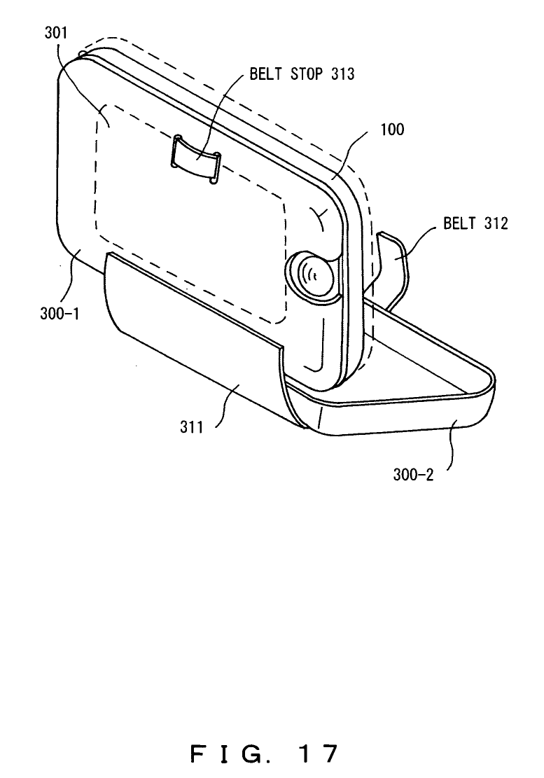

The second example of the camera case shown in FIG. 17 is explained below. The second example is a note-cover-shaped, and is configured by a front side case 300-1 covering the front side of the camera 100, and a back side case 300-2 covering the back of the camera 100 connected through the 311. By closing the 300-2 from the status shown above, and leading the belt 312 through the belt stop 313, the entire camera 100 is covered. The status shown in FIG. 17 is similar to the status shown in FIG. 15A, thereby enabling the camera 100 to capture images, and the power supplied from the camera 100 turns on the backlight 301, thereby illuminating the display unit 1.

Next, the structure of the camera stand 200 which is one of the accessories of the 100 is explained below.

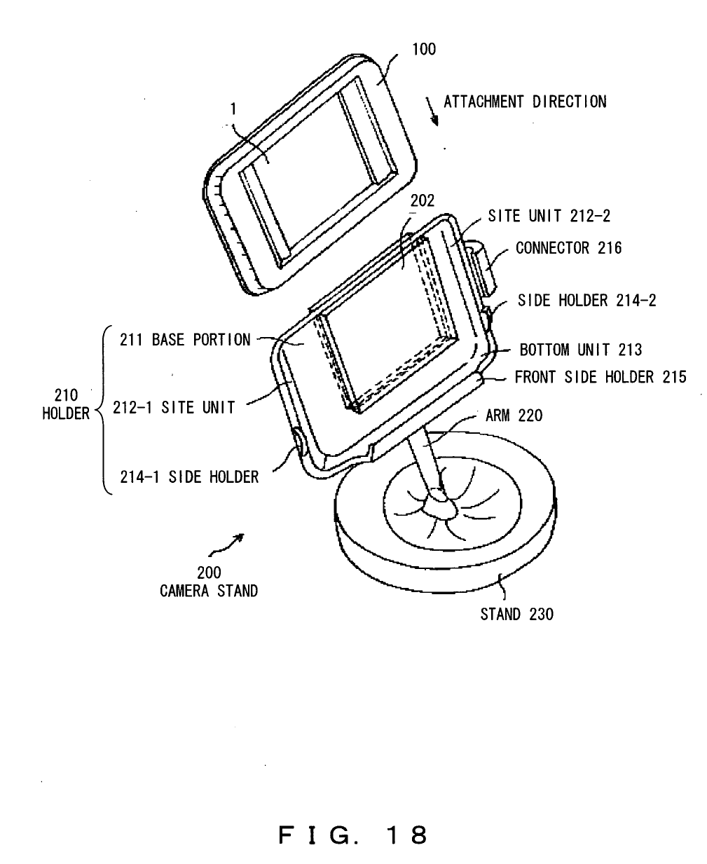

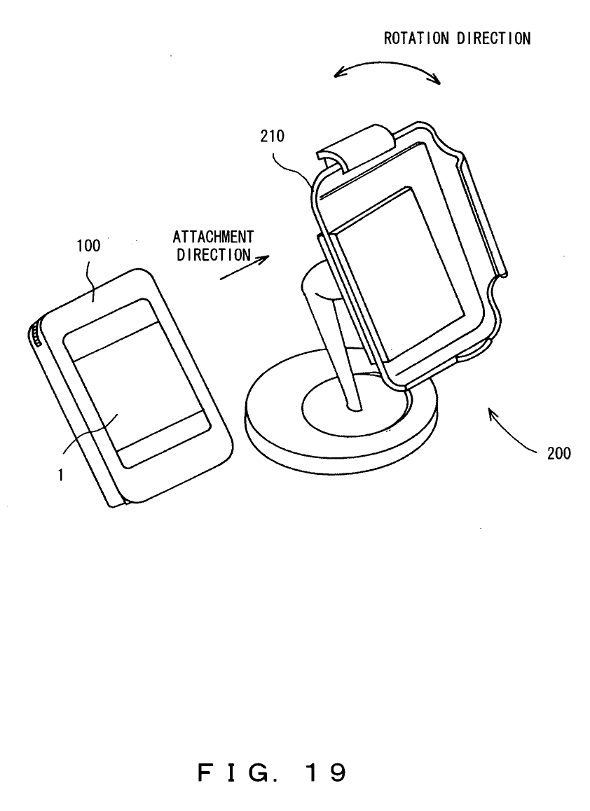

FIGS. 18 and 19 show examples of the camera stand 200. The camera stand 200 is configured by the holder 210 for holding the camera 100, an arm 220 for holding a holder 210, and a stand 230 for uplifting the camera stand 200 by supporting the arm 220. As it is clearly indicated by comparison between FIG. 18 and FIG. 19, the holder 210 is configured to rotate the arm 220 on a fulcrum. For example, depending on the direction of an image to be displayed on the display unit 1, the camera 100 can be held horizontally, vertically, etc. The posture shown in FIG. 19 is appropriate for the observation of an image captured vertically.

The holder 210 is configured by a base portion 211, side units 211-1 and 211-2, and a bottom unit 213. When the camera 100 is slid from above the holder 210 shown in 18, and inserted and set, the front, side, and the bottom of the camera 100 can be held. At this time, the side holders 214-1 and 214-2 and respectively provided for the side units 211-1 and 211-2 hold the camera 100 at the respective sides, and a front side holder 215 holds the camera 100 from the front side.

As shown in FIG. 18, when the display unit 1 of the camera 100 is self illuminating such as an LCD, etc., the base portion 211 of the holder 210 on the camera stand 200 are provided with backlights 202. With the camera 100 attached to the camera stand 200, the backlight 202 is turned on. Then, the display unit 1 is illuminated from the front to improving the visibility of a display.

Furthermore, the side unit 212-2 of the holder 210 is provided with the connector 216. By coupling a connector 216 to the stand contact 14 of the camera 100, the power for operating the camera 100 can be provided by the camera stand 200.

Additionally, the present invention is not limited to the above-mentioned embodiments, and can be further improved and changed within the gist of the present invention.

1. A camera which shoots a subject, and comprises:
a capture unit capturing an image of the subject, and generating image data indicating the image; and
a display unit having light permeability from front to back of a housing of a camera, generating the image of the subject superposed on the subject seen through from the back, and displaying the image on the back.

2. The camera according to claim 1, wherein
a display surface of the display unit is large enough to be seen through from the back in a range of an image captured by the capture unit.

3. The camera according to claim 1, wherein
a housing of the camera is a frame-shaped to encompass the display unit.

4. The camera according to claim 3, wherein
the display surface of the display unit is arranged as lowered from the surface of the housing of the camera.

5. The camera according to claim 4, wherein:
the capture unit comprises a taking lens for forming an image of the subject; and
the taking lens is arranged at a side end unit opposite a grip unit which is a side end unit on the front of the housing of the camera, and is held by a user of the camera for holding the camera.

6. The camera according to claim 3, further comprising
a power supply terminal supplying power for illumination of an accessory having an illumination unit for illuminating the display unit.

7. The camera according to claim 6, wherein
the power supply terminal is mounted on the front side of the camera.

8. The camera according to claim 3, wherein
the display unit displays an image indicated by the image data also on the front side of the camera.

9. The camera according to claim 3, wherein
the display unit is configured using an organic EL (electro-luminescence) display element.

10. An accessory of a camera which shooting a subject, wherein
the camera comprises:
a capture unit capturing an image of the subject and generating image data indicating the image; and
a display unit having light permeability from front to back of a housing of the camera, generating the image of the subject superposed on the subject seen through from the back, and displaying the image on the back, and
the accessory comprises an illumination unit for illuminating the display unit.

11. The accessory according to claim 10, wherein
the accessory is a camera case storing the camera.

12. The accessory according to claim 10, wherein
the camera further comprises a power supply terminal supplying power to the illumination unit; and
the illumination unit illuminates the display unit using power supplied by the power supply terminal.

13. The access according to claim 10, wherein
the accessory is a camera stand loaded with the camera.

14. The accessory according to claim 13, wherein
the camera stand comprises a connector for supplying power to the camera.

15. A camera system having a camera for shooting a subject and an accessory to the camera, wherein:
the camera comprises:
a capture unit capturing an image of the subject and generating image data indicating the image; and
a display unit having light permeability from the front to the back of the housing of a camera, generating the image of the subject superposed on the subject seen through from the back, and displaying the image on the back, and
the accessory includes an illumination unit illuminating the display unit.

16. A camera which shoots a subject, comprising:
a capture unit capturing an image of the subject;
a display unit having light permeability from front to back of a housing of the camera, displaying an image captured by the capture unit, and also displaying information about an area captured by the capture unit as superposed on the image of the subject seen through from the back; and
a shooting area generation unit generating the information about the area based on the capturing magnification of the image in the capture unit.

17. The camera according to claim 16, wherein
the display unit displays the information by encompassing an area captured by the capture unit in a landscape seen through the back side.

18. The camera according to claim 16, further comprising:
a user distance measurement unit measuring a distance between the camera and a user of the camera, wherein
the capture area generation unit generates information indicating the area based on the distance.

19. The camera according to claim 16, wherein:
a user distance measurement unit measuring a distance between the camera and a user of the camera; and
the display unit further displays information about the distance.

20. The camera according to claim 16, further comprising:
a distance measurement unit measuring a distance between the camera and a user of the camera; and
an announcement unit which announces whether or not the distance is in a predetermined range.

21. The camera according to claim 20, wherein
The announcement unit announces by display on the display unit.

22. The camera according to claim 16, further comprising
a subject distance measurement unit measuring a distance between the camera and the subject, and
the capture area generation unit generates information indicating the area based on the distance.

23. The camera according to claim 16, wherein
a housing of the camera is a frame-shaped to encompass the display unit.

24. The camera according to claim 16, wherein
the display unit further displays at least one of diaphragm, shutter speed, and capturing magnification in capture conditions in capturing an image by the capture unit.

25. The camera according to claim 16, wherein
the display unit is configured using an organic EL (electro-luminescence) display element.

26. A camera which shoots a subject, comprising:
a capture unit capturing an image of the subject;
a display unit having light permeability from front to back of a housing of the camera, displaying an image captured by the capture unit, and also displaying information about an area captured by the capture unit as superposed on the image of the subject seen through from the back; and
a shootable area generation unit generating the information about the area based on the shooting conditions in the capturing operation on the image in the capture unit.

27. A camera which shoots a subject, comprising:
a capture unit capturing an image of the subject;
a display unit having light permeability from front to back of a housing of the camera, displaying an image captured by the capture unit, and also displaying at least one of the image of the subject captured by the capture unit and a recorded image captured by the capture unit as superposed on the image of the subject seen through from the back; and
a display setting unit making display setting for an image displayed on the display unit, wherein
the display setting unit makes the display setting based on the shooting condition when the capture unit captures an image.

28. The camera according to claim 27, wherein
the display setting unit sets at least one of a display position displayed by the display unit, a size, and brightness.

29. The camera according to claim 27, wherein
the capture condition includes at least one of a zoom ratio, brightness of a surrounding portion, and a distance from the camera and a subject.

30. The camera according to claim 29, wherein
when a zoom ratio which is the capture condition is set at a wide-angle side, the display unit does not display the subject captured by the capture unit.

31. The camera according to claim 29, wherein
the display setting unit sets brightness of an image displayed by the display unit depending on brightness of the surrounding which is the shooting condition.

32. The camera according to claim 27, further comprising
an instruction obtaining unit obtaining at least one instruction between an instruction of a size of an image displayed by the display unit and an instruction of a position.

33. The camera according to claim 27, further comprising
a shooting area generating unit generating information about an area captured by the capture unit superposed on an image of the subject seen through from the back side based on the shooting condition, wherein
the display unit displays information about the captured area with at least one of an image of the subject captured by the capture unit and the recorded image captured by the capture unit.

34. The camera according to claim 27, further comprising a composite capture unit combining and capturing an image of a subject seen through the back side and the recorded image captured by the capture unit superposed and displayed on the display unit.

35. The camera according to claim 27, wherein
the display unit is configured using an organic EL (electro-luminescence) display element.

36. A camera which shoots a subject, comprising:
a capture unit for capturing an image of the subject; and
a display unit having light permeability and displaying on back of a housing of the camera at least one of the image of the subject captured by the capture unit and a recorded image captured by the capture unit as superposed on the image of the subject seen through from the back of the housing of the camera, and also displaying on the front of the housing of the camera at least one of the image of the subject and the recorded image.

37. The camera according to claim 36, wherein
the display unit is configured using an organic EL (electro-luminescence) display element.

38. The camera according to claim 36, wherein
the display unit further comprises a lightproof unit selectively cutting off at least one of light from a front to a back of a housing of the camera and light from the back to the front.

39. The camera according to claim 36, further comprising
a lightproof unit, mounted on a front side of a housing of the camera in the display unit, and selectively cutting off light from the front to the back of the housing.

40. The camera according to claim 39, wherein
the lightproof unit is configured using an ECD (electro-chromic display) display element.

41. The camera according to claim 39, wherein
the lightproof unit is configured using a light transmission LCD (liquid crystal display).

42. A camera which shoots a subject, comprising:
a capture unit for capturing an image of the subject;
a display unit having light permeability and displaying on back of a housing of the camera at least one of the image of the subject captured by the capture unit and a recorded image captured by the capture unit as superposed on the image of the subject seen through from the back of the housing of the camera; and
a lightproof unit for selectively cutting off the light from the back to the front of the housing of the camera.

43. The camera according to claim 42, wherein
the display unit is configured using an organic EL (electro-luminescence) display element.

44. The camera according to claim 42, wherein
the lightproof unit is configured using an ECD (electro-chromic display) display element.

45. The camera according to claim 42, wherein
the lightproof unit is configured using a light transmission LCD (liquid crystal display).

46. A camera which shoots a subject, comprising:
a capture unit for capturing an image of the subject; and
a display unit, configured using an LCD (liquid crystal display) having light permeability, for displaying on back of a housing of the camera at least one of the image of the subject captured by the capture unit and a recorded image captured by the capture unit as superposed on the image of the subject seen through from the back of the housing of the camera.

47. A camera which shoots a subject, comprising:
a capture unit capturing an image of the subject; and
a display unit having light permeability and selectively displaying on front or back of a housing of the camera at least one of the image of the subject captured by the capture unit and a recorded image captured by the capture unit as superposed on the image of the subject seen through from the back of the housing of the camera.
